(19) United States
(12) Patent Application Publication
(10) Pub. No.: US 2026/0109005 A1
(43) Pub. Date: Apr. 23, 2026

(54) Lateral Attachment Clamps

(71) Applicant: Jason A. Marburger, Spokane, WA (US)

(72) Inventor: Jason A. Marburger, Spokane, WA (US)

(21) Appl. No.: 18/923,468

(22) Filed: Oct. 22, 2024

(51) Int. Cl. B25B 5/10

(52) U.S. Cl. CPC B25B 5/101

(57) ABSTRACT

Lateral attachment clamps are described. In an example, a lateral attachment clamp includes an engagement region that is attached at an angle to a clamp region. The engagement region includes a partial mounting aperture with an opening that is dimensioned to align with a vertical axis in a first orientation of the lateral attachment clamp and intersect with the vertical axis in a second orientation of the lateral attachment clamp. The vertical axis, for instance, is substantially perpendicular to a longitudinal axis of the clamp region when the lateral attachment clamp is disposed in the second orientation. In an example, the vertical axis is a vertical axis of an adjacent member. Accordingly, the lateral attachment clamp is configured to attach to an intermediate portion of the member to achieve a variety of different working positions and scenarios.

### BACKGROUND

Clamps are often used to secure one or more objects to a surface or to one another, such as to provide stability and support for various applications such as construction, welding, woodworking, etc. Accordingly, a wide range of clamp designs exist to accommodate different materials and use cases, such as clamps with varied materials, geometries, sizes, form factors, etc. For instance, a conventional bar clamp includes a fixed jaw and an adjustable jaw affixed to a rail. However, manual adjustment of conventional bar clamps, such as to reposition the adjustable jaw by sliding the adjustable jaw along the rail, can be time-consuming and inefficient for a user. Further, such clamps are cumbersome and cannot be used in situations in which ends of the rail are unavailable to attach a fixed jaw and/or an adjustable jaw and thus have limited versatility.

### SUMMARY

Lateral attachment clamps are described that support attachment to an intermediate portion of a member. An example lateral attachment clamp includes an engagement region that is attached at an angle to a clamp region. The engagement region includes a partial mounting aperture with an opening that is dimensioned to align with a vertical axis in a first orientation of the lateral attachment clamp and intersect with the vertical axis in a second orientation of the lateral attachment clamp. The vertical axis, for instance, is substantially perpendicular to a longitudinal axis of the clamp region when the lateral attachment clamp is disposed in the second orientation.

In an example, the vertical axis is representative of a vertical axis of a member. Accordingly, the partial mounting aperture can attach the lateral attachment clamp to an intermediate portion of the member when the lateral attachment clamp is disposed in the first orientation. The lateral attachment clamp is rotatable into the second orientation to secure the lateral attachment clamp to the member. The clamp region further a clamp component such as a jaw that is positionable in a transverse plane. The transverse plane, for instance, is substantially perpendicular to the vertical axis, e.g., the member, when the lateral attachment clamp is disposed in the second orientation.

In an example, a lateral attachment clamp assembly includes a first lateral attachment clamp attached to an intermediate portion of a member at a first position and a second lateral attachment clamp attached to a different intermediate portion of the member at a second position. The first lateral attachment clamp includes a first jaw located in a first transverse plane, and the second lateral attachment clamp includes a second jaw located in a second transverse plane. When the first lateral attachment clamp and second lateral attachment clamp are disposed in respective second orientations, the first transverse plane and second transverse plane are substantially parallel to one another. Accordingly, a workpiece can be secured between the first jaw and the second jaw. In this way, the techniques described herein support efficient and secure attachment of clamp components to intermediate portions of members to achieve a variety of different working scenarios.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 depicts a view of an example lateral attachment clamp in accordance with one or more implementations described herein.

FIG. 2 depicts a top view of the lateral attachment clamp in accordance with one or more implementations described herein.

FIG. 3 depicts an example of the lateral attachment clamp from a first view and a second view in accordance with one or more implementations described herein.

FIG. 4 depicts an example of attachment of the lateral attachment clamp to a member in accordance with one or more implementations described herein.

FIG. 5 depicts an example in which an external surface of the lateral attachment clamp includes one or more apertures in accordance with one or more implementations described herein.

FIG. 6 depicts an example of the lateral attachment clamp in which components of the clamp component are shown disengaged from one another in accordance with one or more implementations described herein.

FIG. 7 depicts a view of a lateral attachment clamp assembly in accordance with one or more implementations described herein.

FIGS. 8a and 8b depict examples of attachment of a first clamp and a second clamp to a member in accordance with one or more implementations described herein.

FIGS. 9a and 9b depict an example usage scenario of the lateral attachment clamp assembly in accordance with one or more implementations described herein.

FIG. 10 depicts a lateral attachment clamp that includes a rotational component in accordance with one or more implementations described herein.

### DETAILED DESCRIPTION

### Overview

Lateral attachment clamps are described. In an example implementation, a lateral attachment clamp includes an engagement region and a clamp region that are attached to one another. Generally, the engagement region is configured to attach the lateral attachment clamp to an intermediate portion of a member while the clamp region includes one or more tools to provide various functionalities once the lateral attachment clamp is attached to the member.

The engagement region has a proximal end attached to the clamp region and a distal end. The engagement region includes a partial mounting aperture disposed between the proximal end and the distal end that is dimensioned to align with a vertical axis in a first orientation of the lateral attachment clamp and intersect with the vertical axis in a second orientation of the lateral attachment clamp. The vertical axis, for instance, can be defined as a vertical axis of a member. Accordingly, the partial mounting aperture can attach the lateral attachment clamp to the member while the lateral attachment clamp is in the first orientation. The partial mounting aperture is further dimensioned to secure the lateral attachment clamp to the member when the lateral attachment clamp is disposed in the second orientation.

For instance, the partial mounting aperture includes an opening such that in the first orientation the member is insertable into the lateral attachment clamp through the opening. Consider an example in which the member is a beam such as a 2×4 length of wood that is embedded on both ends, e.g., affixed to a floor and a ceiling. Conventional approaches are unable to efficiently attach clamp devices to the beam due to the ends being embedded. For instance, conventional approaches are unable to “slide” clamp devices onto either of the ends of the beam.

Using the techniques and embodiments described herein, however, the opening is dimensioned such that in the first orientation, the member “fits” through the opening and into an internal cavity of the partial mounting aperture when aligned with the opening. The lateral attachment clamp is then rotated from the first orientation to a second orientation, such as via clockwise and/or counterclockwise rotation. In the second orientation, the member is misaligned with the opening to constrain the member within the internal cavity of the partial mounting aperture.

In some examples, the partial mounting aperture includes one or more wings located on either or both sides of the opening. The wings are configured to at least partially enclose the member within the partial mounting aperture when the lateral attachment clamp is disposed in the second orientation. The wings can be tapered, such as to accommodate members of different widths.

The partial mounting aperture may further include one or more internal surfaces that include one or more contact faces. The contact faces, for instance, are dimensioned to contact the member when the lateral attachment clamp is in the second orientation with the member disposed within the partial mounting aperture. In various examples, the contact faces are configured to secure the lateral attachment clamp to the member in the second orientation and prevent movement of the lateral attachment clamp with respect to the vertical axis of the member, e.g., to prevent the lateral attachment clamp from “sliding.” Accordingly, the lateral attachment clamp is attachable to an intermediate portion of a member, which is not possible using conventional techniques and/or clamp devices that are permanently secured to a rail or are only attachable to the rail at one or more ends of the rail.

The lateral attachment clamp further includes the clamp region that has a proximal end and a distal end. The distal end of the lateral attachment clamp is attached to the proximal end of the engagement region. In one or more examples, the clamp region is attached to the engagement region at an angle, such that once the lateral attachment clamp is rotated into the second region the clamp component is positioned at a desirable angle with respect to the member. For instance, the clamp region is attached to the engagement region at an angle such that once the lateral attachment clamp is rotated into the second region the clamp component is substantially perpendicular to the member. In at least one example, the angle between the engagement region and the clamp region is such that when disposed in the second position, the clamp region forms an acute interior angle with the member. In this way, the techniques described herein can accommodate for deflection of the member as further described below.

The proximal end of the clamp region includes one or more tools such as one or more clamp components that contribute to functionality of a clamp. In one example, the clamp component includes a fixed jaw positionable in a transverse plane, the transverse plane substantially perpendicular to the member in the second orientation. In an additional or alternative example, the clamp component includes an aperture located at the proximal end of the clamp region, a spindle movably positioned within the aperture, and an actuation component to control a position of a movable jaw with respect to the aperture. This is by way of example and not limitation, and a variety of clamp components are considered, as described in more detail below.

In an example, a lateral attachment clamp assembly includes a first lateral attachment clamp attached to an intermediate portion of a member at a first position and a second lateral attachment clamp attached to a different intermediate portion of the member at a second position. The first lateral attachment clamp includes a first jaw located in a first transverse plane, and the second lateral attachment clamp includes a second jaw located in a second transverse plane. When the first lateral attachment clamp and second lateral attachment clamp are disposed in respective second orientations, the first transverse plane and the second transverse plane are substantially parallel to one another. Accordingly, the first jaw and the second jaw can be aligned with one another such as to function as a clamp to secure a workpiece between the first jaw and the second jaw.

For instance, the first jaw is a movable jaw that is movably positioned along a vertical axis while the second jaw is a fixed jaw. A workpiece can be secured adjacent to the member by positioning the workpiece between the first jaw and the second jaw and secured by controlling a position of the first jaw relative to the second jaw. In this way, the techniques described herein support efficient attachment of clamp components to a variety of positions of members to achieve a variety of different working scenarios.

Accordingly, the described lateral attachment clamps assemblies provide for a multitude of configurations and workpiece arrangements not provided by conventional tools for securing workpieces. In the following discussion, example lateral attachment clamps assemblies are described that may employ the techniques described herein. Example scenarios are also described in which the example lateral attachment clamps and assemblies are utilized. The example lateral attachment clamps and assemblies are not limited to performance of the example scenarios.

### Lateral Attachment Clamps and Assemblies

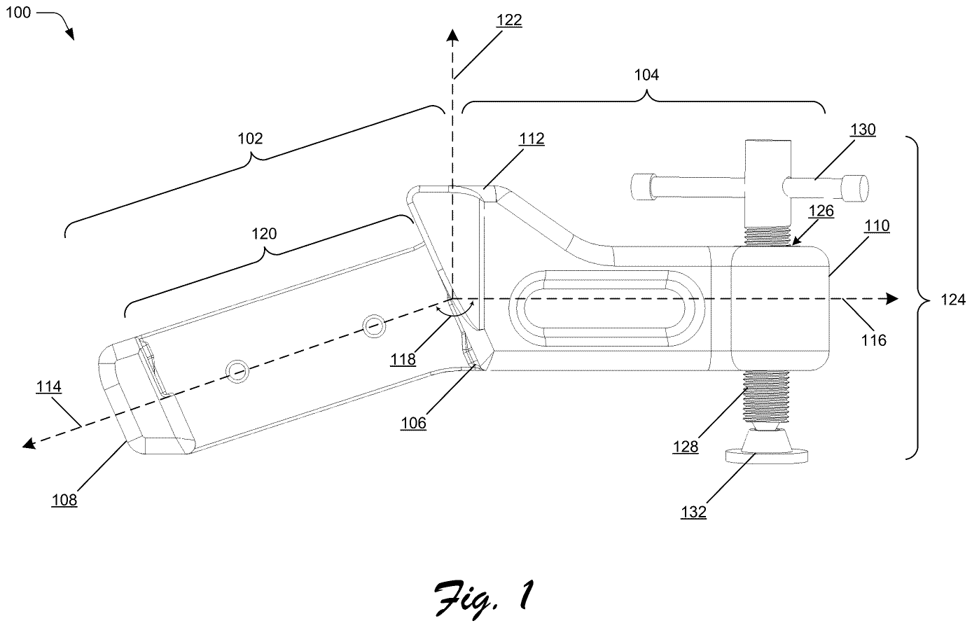

FIGS. 1-10 depict various attributes of example lateral attachment clamps that are operable to employ techniques described herein. FIG. 1 depicts a view of an example lateral attachment clamp 100 in accordance with one or more implementations described herein. In the illustrated example, the lateral attachment clamp 100 includes an engagement region 102 and a clamp region 104 that are attached to one another.

The engagement region 102 includes a proximal end 106 and a distal end 108, and the clamp region includes a proximal end 110 and a distal end 112. The proximal end 106 of the engagement region 102, for instance, is attached to the distal end 112 of the clamp region 104. The engagement region 102 and the clamp region 104 can be attached to one another in a variety of ways.

In one example, the engagement region 102 and the clamp region 104 are independent bodies that are fastened together using one or more suitable machining and/or manufacturing techniques, such as using interlocking joints, one or more adhesives, mechanical fasteners, etc. In an additional or alternative example, the engagement region 102 and the clamp region 104 are fabricated together using one or more suitable manufacturing techniques, such as injection molding, die casting, 3D printing, CNC milling, laser cutting, etc.

In the illustrated example, the engagement region 102 and the clamp region 104 are attached to one another at an angle. For instance, an intersection of a longitudinal axis 114 of the engagement region 102 and a longitudinal axis 116 of the clamp region 104 forms an intersection angle 118. Generally, the intersection angle 118 is configured such that when the lateral attachment clamp 100 is secured to a member, the clamp region 104 forms a particular desired angle with the member as further described in more detail below.

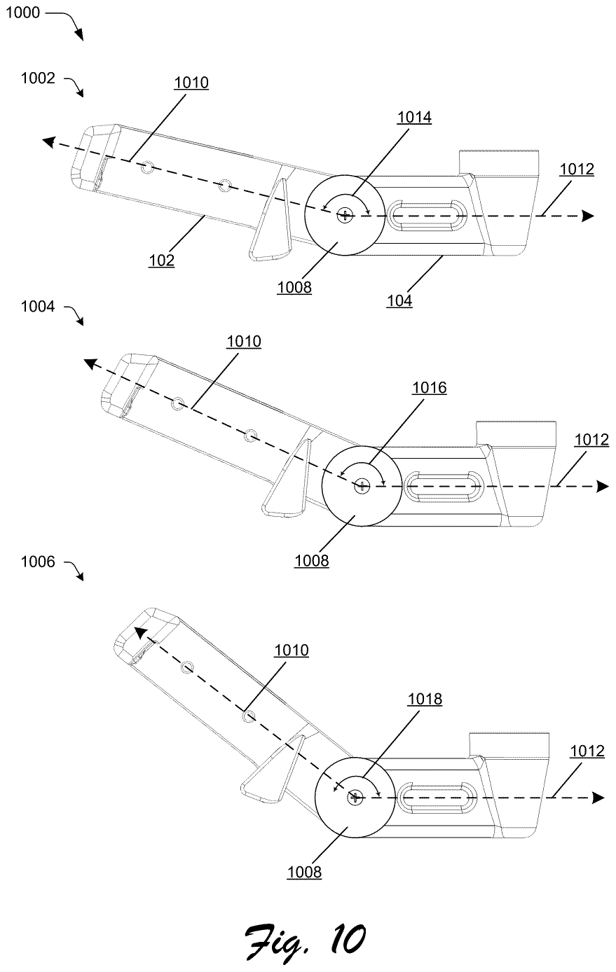

In the illustrated example, the intersection angle 118 forms an obtuse angle, such as in a range of 145 degrees to 165 degrees. This is by way of example and not limitation, and various embodiments and implementations are considered such that the intersection angle 118 can range from greater than zero degrees to less than 360 degrees. In various examples, the engagement region 102 and the clamp region 104 are attached via a rotational component, such that the intersection angle 118 is adjustable by a user and/or automatically and without user intervention as further described in more detail below with respect to FIG. 10.

The engagement region 102 further includes a partial mounting aperture 120. In the illustrated example, the partial mounting aperture 120 is disposed between the distal end 108 and the proximal end 106 of the engagement region 102. The partial mounting aperture 120 is dimensioned to align with a vertical axis 122 in a first orientation of the lateral attachment clamp 100 and intersect with the vertical axis 122 in a second orientation of the lateral attachment clamp 100. The vertical axis 122, for instance, is substantially perpendicular to a longitudinal axis 116 of the clamp region 104 when the lateral attachment clamp 100 is disposed in the second orientation as depicted in the illustrated example.

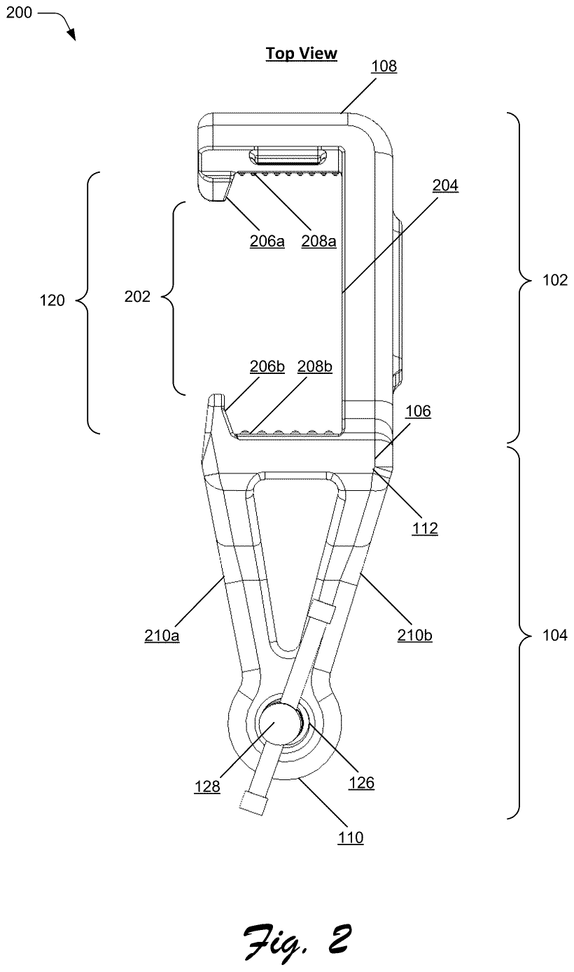

Accordingly, the partial mounting aperture 120 is dimensioned to attach the lateral attachment clamp 100 to a member while the lateral attachment clamp 100 is disposed in a first orientation. The partial mounting aperture 120 is further dimensioned to secure the lateral attachment clamp 100 to the member (e.g., to affix the lateral attachment clamp 100 at a position along a length of the member) when the lateral attachment clamp is disposed in a second orientation. The partial mounting aperture 120 is described in more detail below, such as with respect to FIG. 2.

The clamp region 104 further includes a tool component such as a clamp component 124. A variety of clamp components 124 are considered, such as one or more of a fixed jaw, ratchet clamp, pneumatic clamp, pipe clamp, parallel clamp, corner clamp, etc. In the illustrated example, the clamp component 124 includes an aperture 126, a spindle 128, an actuation component 130, and a movable jaw 132. The spindle 128, for instance, is movably positioned within the aperture 126. The actuation component 130 is operable (such as via user interaction to engage the actuation component 130) to control a position of the spindle 128 within the aperture 126 and thereby control a position of the movable jaw 132 relative to the aperture 126. Example properties and configurations of the clamp component 124 are discussed in more detail below, such as with respect to FIG. 6.

FIG. 2 depicts a top view 200 of the lateral attachment clamp 100 in accordance with one or more implementations described herein. In the illustrated example, the partial mounting aperture 120 is substantially enclosed on three sides. In various examples, the partial mounting aperture 120 can be disposed on either side of the engagement region 102.

The partial mounting aperture 120 is depicted to include an opening 202 and a rear surface 204. The opening 202, for instance, is dimensioned to align with a vertical axis 122 in a first orientation of the lateral attachment clamp 100 and intersect with the vertical axis 122 in a second orientation of the lateral attachment clamp 100. As described above, in various examples the vertical axis 122 is substantially perpendicular to a longitudinal axis 116 of the clamp region 104 when the lateral attachment clamp 100 is disposed in the second orientation.

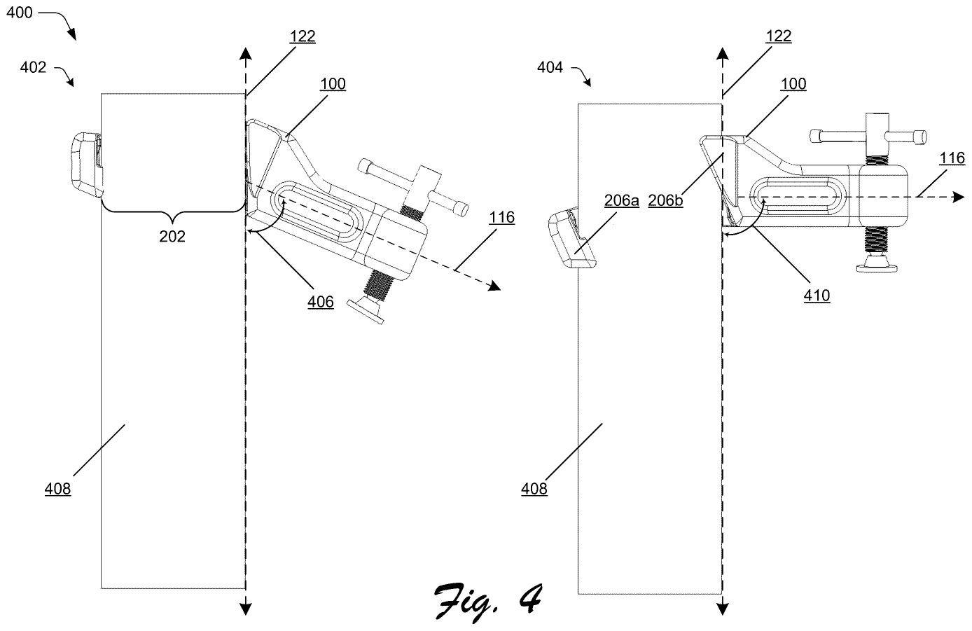

In various examples, the vertical axis 122 is representative of a vertical axis of a member. Accordingly, the opening 202 is dimensioned such that an intermediate portion of the member (e.g., a middle of a rectangular beam) is insertable into an interior portion (e.g., a cavity region) of the partial mounting aperture 120. For instance, the intermediate portion of the member can be inserted through the opening 202, towards the rear surface 204, when the lateral attachment clamp 100 is positioned in a first orientation as further shown below in FIG. 4. A variety of member shapes, sizes, lengths, widths, etc. are considered, and thus the opening 202 can have a variety of shapes, dimensions, and/or geometries.

The opening 202 is further dimensioned such that rotation of the lateral attachment clamp 100 into a second orientation causes the member to be misaligned with the opening 202. Misalignment of the member with the opening 202, for instance, causes the member to be constrained within the interior portion of the partial mounting aperture 120. It should further be understood that the intermediate portion of the member can be inserted and/or removed from the lateral attachment clamp 100 via movement and/or rotation of either or both the lateral attachment clamp 100 and/or the member.

In various embodiments, the partial mounting aperture 120 further includes one or more wings, e.g., a first wing 206a and a second wing 206b. In the illustrated example, the first wing 206a is disposed on a side of the opening 202 adjacent to the distal end 108 of the engagement region 102 while the second wing 206b is disposed on an opposite side of the opening 202 adjacent to the proximal end 106 of the engagement region 102. The wings 206a, 206b are substantially parallel to the vertical axis 122 when the lateral attachment clamp 100 is disposed in the first orientation and at least one of the wings 206a, 206b is configured to intersect the vertical axis 122 when the lateral attachment clamp 100 is disposed in the second orientation. In this way, the wings 206a, 206b are configured to at least partially enclose the member within the partial mounting aperture 120, such as upon insertion of the member into the lateral attachment clamp 100 in the first orientation and rotation of the lateral attachment clamp 100 to the second orientation.

As depicted in this example, the wings 206a, 206b further include a taper, such as to accommodate for variable widths of members that can be inserted into the partial mounting aperture 120. For instance, the first wing 206a has a tapered profile such that the first wing 206a (as viewed from above) gradually increases in width as the first wing 206a extends towards the distal end 108 of the engagement region 102. Similarly, the second wing 206b has a tapered profile such that second wing 206b, when viewed from above, gradually increases in width along a length of the second wing 206b, e.g., as the second wing 206b extends towards the proximal end 106 of the engagement region 102. An angle of the taper for either or both of the first wing 206a and/or the second wing 206b may be constant or variable.

The partial mounting aperture 120 can further include one or more contact faces, e.g., a first contact face 208a and a second contact face 208b, on one or more interior surfaces of the partial mounting aperture 120. In various examples, the contact faces 208a, 208b are formed at an angle relative to adjacent interior surfaces of the partial mounting aperture 120. In at least one example, one or more of the contact faces 208a, 208b are substantially parallel to the vertical axis 122 when the lateral attachment clamp 100 is disposed in the second orientation.

Accordingly, the contact faces 208a, 208b are configured to secure the member within the opening 202 while the lateral attachment clamp 100 is in the second orientation. In the illustrated example, the first contact face 208a and the second contact face 208b each include a tooth configuration that secure the member within the partial mounting aperture 120, such as by introducing friction to “grip” the member. In some examples, one or more of the first contact face 208a and/or the second contact face 208b are substantially coplanar with exterior faces of the member when the lateral attachment clamp 100 is in the second orientation.

Further, the first contact face 208a and/or the second contact face 208b are configured to apply a concentrated force to the member to further secure the lateral attachment clamp 100 to the member during a clamping operation. For instance, an upward force on the movable jaw 132 causes the first contact face 208a to engage the member at a first position with a first force vector that has a first magnitude and direction. The upward force on the movable jaw 132 further causes the second contact face 208b to engage the member at a second position with a second force vector that has a second magnitude and direction. In at least one example, the first force vector is in opposition (partially or wholly) to the second force vector. In this way, the first force vector and second force vector are operable to create a mechanical interlock between the lateral attachment clamp 100 and the member.

While in the illustrated example an interior cavity of the partial mounting aperture 120 is depicted as having a substantially rectangular shape, it should be understood that a variety of shapes, dimensions, and/or geometries are considered, such as to accommodate variations in member shape, dimension, and/or geometry. In at least one example, the partial mounting aperture 120 is dimensioned to attach to and secure a cylindrical member. In such an example, one or more of the first contact face 208a and/or the second contact face 208b may be contoured (e.g., rounded) to contact the cylindrical member. This is by way of example and not limitation, and a variety of shapes, dimensions, and/or geometries of the partial mounting aperture 120 are considered.

As further shown in this example, the clamp region 104 includes a first arm 210a and a second arm 210b. The first arm 210a and the second arm 210b are configured to converge toward a common point towards the proximal end 110 of the clamp region 104. For instance, towards the distal end 112 of the clamp region 104, the first arm 210a and the second arm 210b are separated by an initial distance. Moving towards the proximal end 110 of the clamp region 104, a distance between the first arm 210a and the second arm 210b decreases until the first arm 210a and the second arm 210b are joined at the common point, e.g., at the proximal end 110 of the clamp region 104. In various embodiments, the clamp region 104 is configured in this way to maximize structural integrity while increasing ease of manufacturability. The view 200 further depicts the aperture 126, through which the spindle 128 is inserted.

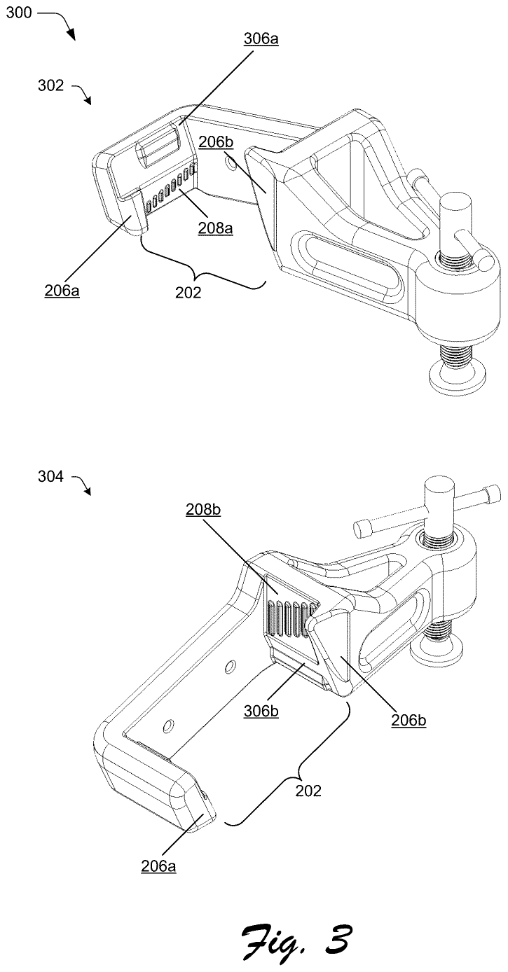

FIG. 3 depicts an example 300 of the lateral attachment clamp 100 from a first view 302 and a second view 304 in accordance with one or more implementations described herein. As shown in the illustrated example 300, the first wing 206a and the second wing 206b are angled. In one or more examples, the first wing 206a and/or the second wing 206b are angled to be substantially perpendicular to the longitudinal axis 114 of the engagement region 102.

In the illustrated example, the first wing 206a and the second wing 206b are parallel to one another. For instance, a distance between a surface of the first wing 206a bordering the opening 202 and a surface of the second wing 206b bordering the opening 202 is constant. This distance can be configured to correspond to a width of a particular member. In this way, the particular member can be inserted through the opening 202, e.g., between the first wing 206a and the second wing 206b, into the partial mounting aperture 120, such as when the lateral attachment clamp 100 is in a first configuration.

As further illustrated, the partial mounting aperture 120 includes the first contact face 208a and the second contact face 208b. As described above, the contact faces 208a, 208b are configured to secure the member within the opening 202 while the lateral attachment clamp 100 is in the second orientation. In the illustrated example, the first contact face 208a and the second contact face 208b each include a tooth configuration that includes diagonally ascending teeth to grip the member to prevent slippage of the lateral attachment clamp 100. In this example, the first contact face 208a and the second contact face 208b are substantially parallel to one another.

Further, the first contact face 208a and the second contact face 208b are angled relative to adjacent interior faces of the partial mounting aperture 120. For instance, the first contact face 208a is angled relative to an adjacent interior face 306a. In some examples, the adjacent interior face 306a has a substantially similar angle as the first wing 206a. The second wing 206b is formed at an angle relative to an adjacent interior face 306b. In some examples, the adjacent interior face 306b has a substantially similar angle as the second wing 206b.

FIG. 4 depicts an example 400 of attachment of the lateral attachment clamp 100 to a member in first stage 402 and a second stage 404 in accordance with one or more implementations described herein. As illustrated in the first stage 402, the lateral attachment clamp 100 is disposed in a first orientation, e.g., rotated such that the longitudinal axis 116 of the clamp region 104 forms an acute angle 406 with a vertical axis 122, e.g., with a vertical axis of a member 408. In this example, the member 408 is representative of a beam with a rectangular cross section, e.g., a 2×4 length of wood, however this is by way of example and a variety of shapes, dimensions, and geometries of the member 408 are considered. In the first orientation, the opening 202 of the partial mounting aperture 120 is aligned with the member 408 such that the member 408 can be inserted into the internal cavity of the partial mounting aperture 120.

Progressing to the second stage 404, the lateral attachment clamp 100 has been rotated (e.g., rotated counterclockwise) to achieve a second orientation. For instance, an angle 410 formed between the longitudinal axis 116 of the clamp region 104 and a vertical axis of the member 408 is a substantially perpendicular angle. This is by way of example and not limitation, and in various examples the angle 410 is an acute angle, such as to accommodate for deflection of the member 408 and/or the lateral attachment clamp 100 such as during use of the clamp component 124. As illustrated, in the second orientation the member 408 is disposed within the partial mounting aperture 120 of the lateral attachment clamp 100. The member 408 is misaligned with the opening 202 to constrain the member 408 within the partial mounting aperture 120.

Further, in the second orientation depicted in the second stage 404, the first wing 206a and the second wing 206b partially enclose the member 408 within the partial mounting aperture 120 and in this way prevent lateral movement of the lateral attachment clamp 100 with respect to the member 408. The partial mounting aperture 120 further includes a first contact face 208a and a second contact face 208b to contact the member 408 while in the second orientation to prevent unintended vertical movement of the lateral attachment clamp 100 with respect to the member 408. In this way, the techniques described herein provide secure attachment of the lateral attachment clamp 100 to an intermediate portion of the member 408, which is not possible using conventional devices and methodologies. Further, in some examples the lateral attachment clamp 100 can be disposed in between the first and second orientation, such as to efficiently reposition the lateral attachment clamp 100 along the vertical axis of the member 408.

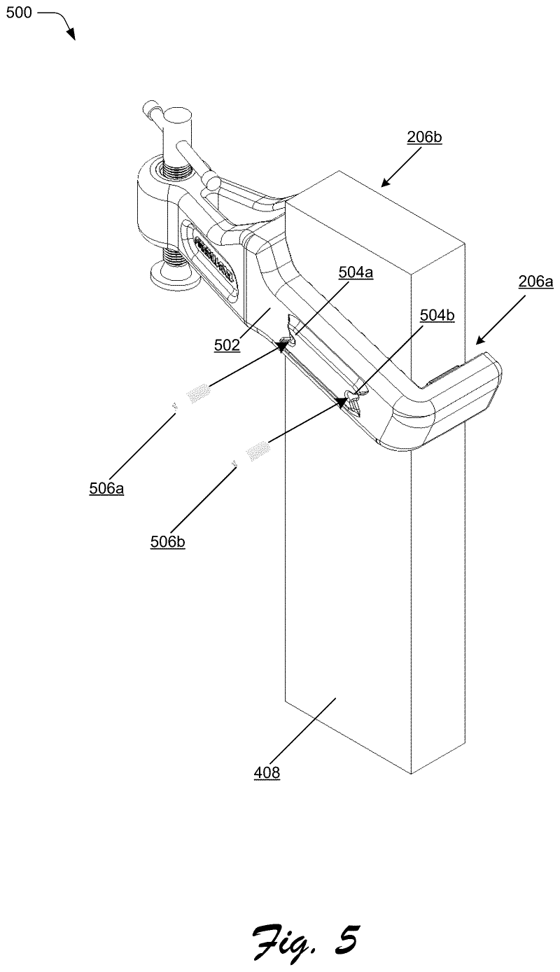

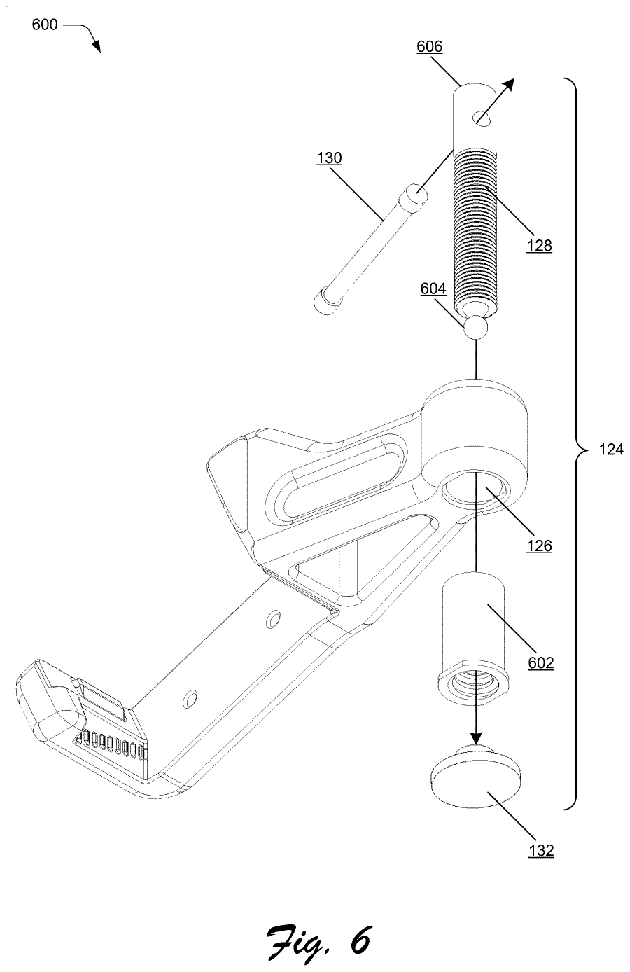

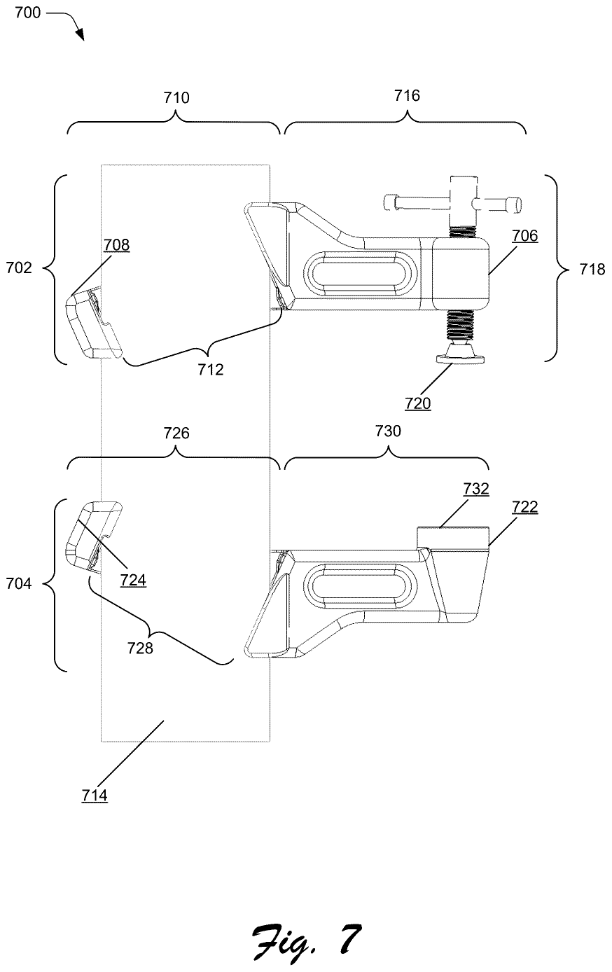

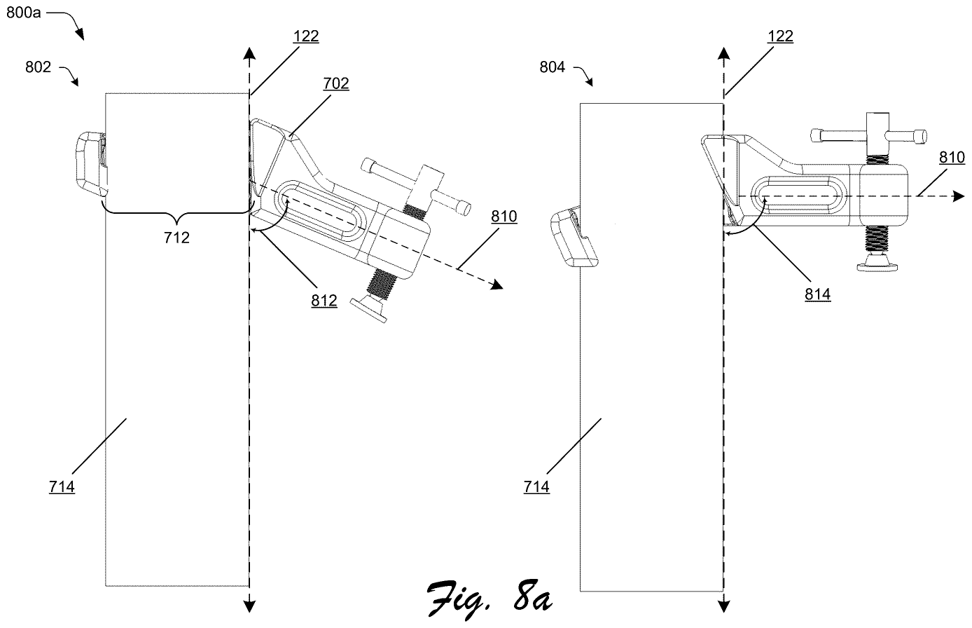

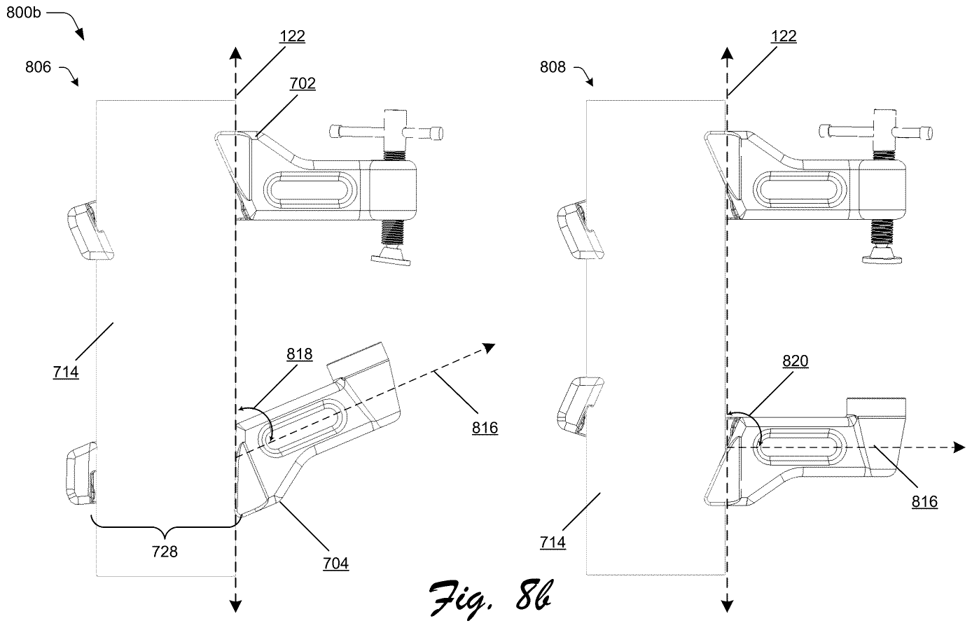

FIG. 5 depicts an example 500 in which an external surface of the lateral attachment clamp 100 includes one or more apertures in accordance with one or more implementations described herein. For instance, in the illustrated example a side surface 502 of the lateral attachment clamp 100 includes a first aperture 504a and a second aperture 504b. The first aperture 504a and the second aperture 504b, for instance, extend through the side surface 502 into an interior portion of the partial mounting aperture 120 and are configured to house one or more fasteners, such as to further secure the lateral attachment clamp 100 to the member in the second orientation.

For instance, the lateral attachment clamp 100 is depicted in the second orientation with the member 408 secured within the partial mounting aperture 120. To further affix the lateral attachment clamp 100 to the member 408, a first fastener 506a is inserted through the first aperture 504a to contact the member 408. Similarly, a second fastener 506b is inserted though the second aperture 504b to contact the member 408. In this example, the first fastener 506a and the second fastener 506b provide a press-fit connection, such as to join the lateral attachment clamp 100 to the member 408 through mechanical interference.

For instance, the first fastener 506a and second fastener 506b include threads that correspond to respective threads of the first aperture 504a and the second aperture 504b. Tightening the first fastener 506a within the first aperture 504a and the second fastener 506b within the second aperture 504b generates a compressive force on the member 408 by pressing the member 408 into the first wing 206a and the second wing 206b. In an additional or alternative example, the first fastener 506a and/or the second fastener 506b include one or more of a screw, nail, bolt, rivet, pin, etc.

FIG. 6 depicts an example 600 of the lateral attachment clamp 100 in which components of the clamp component 124 are shown disengaged from one another in accordance with one or more implementations described herein. In the illustrated example, the clamp component 124 includes the actuation component 130, the spindle 128, the aperture 126, the movable jaw 132, and an insert 602. The insert 602, for instance, is dimensioned to coincide with the aperture 126 such that the insert 602 can be secured (e.g., press fit) within the aperture 126. In various examples, the insert 602 and/or the aperture 126 are shaped to prevent rotation of the insert 602 when disposed within the aperture 126. For instance, the insert 602 includes one or more notches dimensioned to coincide with one or more corresponding notches of the aperture 126 to secure the insert 602 at a rotational position within the aperture 126.

The insert 602 can also be tapped, such that an internal surface of the insert 602 includes a configuration of threads. In an example, the spindle 128 is a threaded rod that has threads that correspond to the configuration of threads of the insert 602, such that the spindle 128 can be movably positioned within the insert 602. In various implementations, the lateral attachment clamp 100 and the insert 602 are fabricated from differing materials. By way of example and not limitation, the lateral attachment clamp 100 is fabricated using aluminum and the insert 602 is fabricated from steel, such as to prevent deformation of threads of the insert 602 during movement of the spindle 128 with respect to the insert 602.

The spindle 128 includes a proximal end 604 and a distal end 606. The proximal end 604 of the spindle 128 includes a ball that is attachable to a corresponding socket of the movable jaw 132 such as to form a movable ball joint to enable rotation of the movable jaw 132 to better contact a workpiece as part of a clamping operation. The distal end 606 of the spindle 128 is attachable to the actuation component 130. The actuation component 130 can control a relative location of the movable jaw 132 such as by controlling a position of the spindle 128 with respect to the insert 602. In the illustrated example, the actuation component 130 includes a sliding pin handle that may be rotated either clockwise or counterclockwise to position the movable jaw 132 closer to or further from the insert 602.

The clamp component 124 depicted in FIG. 6 is by way of example and not limitation and a variety of clamp components 124 are considered. For instance, the clamp component 124 can include one or more of a fixed jaw, ratchet clamp, pneumatic clamp, pipe clamp, parallel clamp, corner clamp, etc. Further, in various examples the proximal end 110 of the clamp region 104 includes one or more tool components in addition to and/or instead of the clamp component 124. For instance, the clamp region 104 can include one or more of a saw guide, tool holder/organizer, drill press mount, measurement tools (e.g., tape measure, level, etc.), lighting tools, electrical outlets, work support jigs, storage holders/buckets, bottle holders, etc. Accordingly, the techniques described herein and lateral mounting apparatus (such as the partial mounting aperture 120) are extensible to support secure attachment of a variety of tools to intermediate portions of members.

### Lateral Attachment Clamp Assemblies

FIG. 7 depicts a view of a lateral attachment clamp assembly 700 in accordance with one or more implementations described herein. In this example, the lateral attachment clamp assembly 700 includes a first lateral attachment clamp, e.g., a first clamp 702 and a second lateral attachment clamp, e.g., a second clamp 704. The first clamp 702 and/or the second clamp 704 can include one or more properties of the lateral attachment clamp 100 as described above.

For instance, the first clamp 702 has a proximal end 706 and a distal end 708. The distal end 708 includes a first engagement region 710. The first engagement region 710 includes a first partial mounting aperture 712 that is dimensioned to attach the first clamp 702 to an intermediate portion of a member 714 while in a first orientation such as in accordance with the techniques described above. The first partial mounting aperture 712 is further configured to affix the first clamp 702 to the intermediate portion of the member 714 while the first clamp 702 is disposed in a second orientation, e.g., the orientation depicted in the illustrated example.

The proximal end 706 includes a first clamp region 716 that includes a clamp component 718. The clamp component 718, for instance, includes one or more properties of the clamp component 124 as described above. In the illustrated example, the clamp component 718 includes a first jaw 720 that is located in a first transverse plane when the first lateral attachment clamp is in the second orientation. The first jaw 720 may also be movable along a vertical axis, such as in accordance with the techniques described above with respect to FIG. 6.

The second clamp 704 has a proximal end 722 and a distal end 724. The distal end 724 includes a second engagement region 726. The second engagement region 726 includes a second partial mounting aperture 728 that is dimensioned to attach the second clamp 704 to a different intermediate portion of the member 714 while in a first orientation such as in accordance with the techniques described above. The second partial mounting aperture 728 is further configured to affix the second clamp 704 to the different intermediate portion of the member 714 while the second clamp 704 is disposed in a second orientation, e.g., the orientation depicted in the illustrated example.

The proximal end 722 of the second clamp 704 includes a second clamp region 730 that includes a second jaw 732. In this example, the second jaw 732 is a fixed jaw and is located in a second transverse plane when the second clamp 704 is in a second orientation, e.g., the depicted orientation. In the illustrated example, the second transverse plane that includes the second jaw 732 is substantially parallel to the first transverse plane that includes the first jaw 720. Accordingly, the lateral attachment clamp assembly 700 is usable to secure an object, e.g., a workpiece, between the first jaw 720 and the second jaw 732.

FIGS. 8a and 8b depict examples 800a and 800b of attachment of the first clamp 702 and the second clamp 704 to a member 714 in a first stage 802, a second stage 804, a third stage 806, and a fourth stage 808 in accordance with one or more implementations described herein. As illustrated in the first stage 802, the first clamp 702 is disposed in a first orientation, e.g., rotated clockwise such that a longitudinal axis 810 of the first clamp region 716 forms an acute angle 812 with the vertical axis 122, e.g., with a vertical axis of the member 714. In the first orientation, an opening of the first partial mounting aperture 712 is aligned with the member 714 such that the member 714 can be inserted into an internal cavity of the first partial mounting aperture 712.

Progressing to the second stage 804, the first clamp 702 has been rotated (e.g., rotated counterclockwise) to achieve a second orientation. For instance, an angle 814 formed between the longitudinal axis 810 and the vertical axis 122, e.g., the vertical axis of the member 714, is a substantially perpendicular angle. As illustrated, in the second orientation the member 714 is disposed within the first partial mounting aperture 712.

The member 714 is misaligned with the opening of the first partial mounting aperture 712 such that the member 714 is constrained within the partial mounting aperture 120. In accordance with the techniques described above, the first clamp 702 may further include one or more wings, apertures to house fasteners, and/or contact surfaces to further secure the first clamp 702 to the member 714 in the second orientation. The first clamp 702 may further be disposed in between the first orientation and the second orientation, such as to efficiently reposition the first clamp 702 along the vertical axis of the member 714.

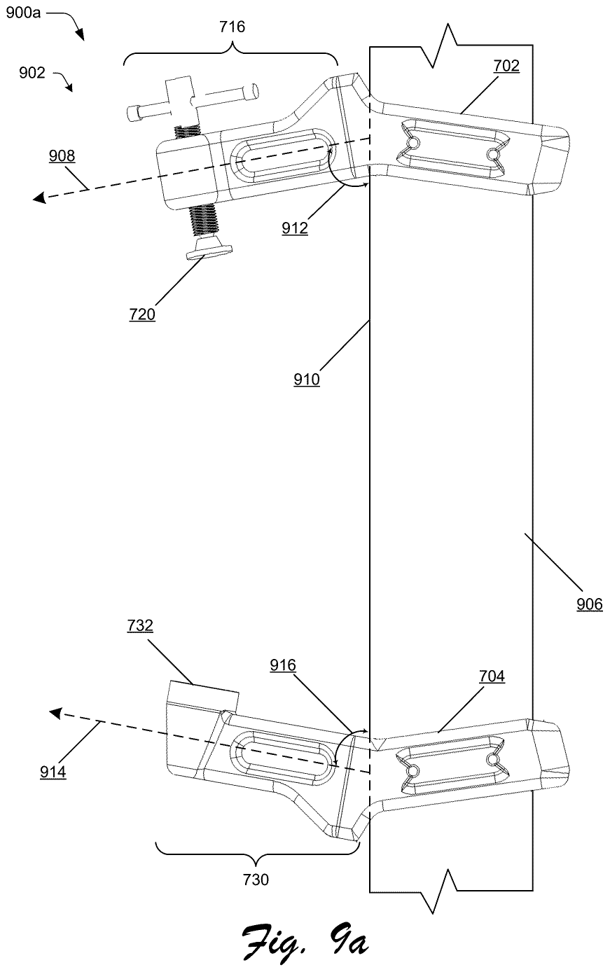

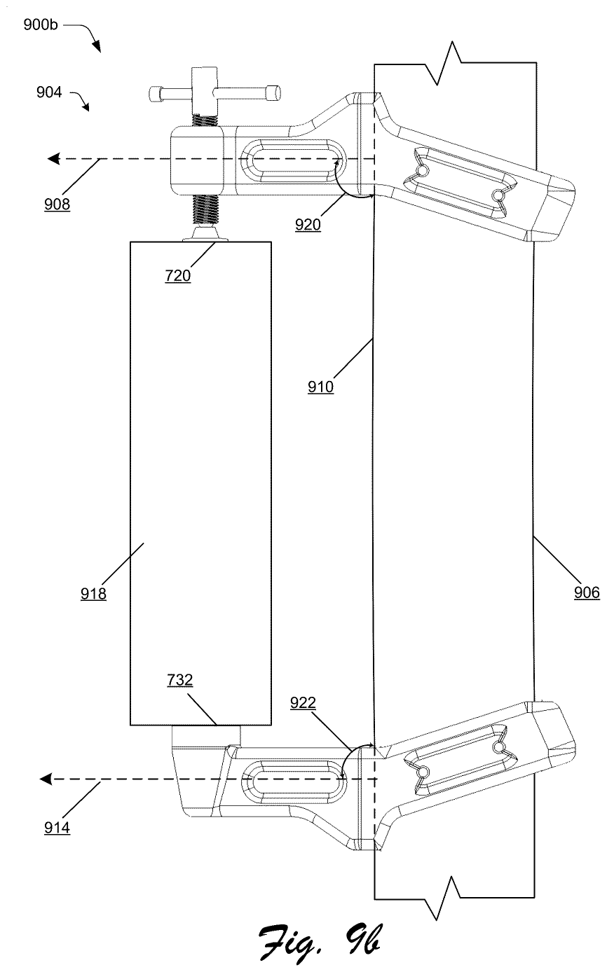

Progressing to the third stage 806, the first clamp 702 is attached to the member 714 in the second orientation. The second clamp 704 is disposed in a first orientation, e.g., rotated counterclockwise such that a longitudinal axis 816 of the second clamp region 730 forms an acute interior angle 818 with the vertical axis 122, e.g., the vertical axis of the member 714. In the first orientation, an opening of the second partial mounting aperture 728 is aligned with the member 714 such that the member 714 can be inserted into an internal cavity of the second partial mounting aperture 728.

Whereas the first clamp 702 is attachable to the member 714 via clockwise rotation to achieve the first orientation, the second clamp 704 is attachable to the member 714 via counterclockwise rotation to achieve the first orientation. That is, in various examples a geometry of the second clamp 704 may “mirror” a geometry of the first clamp 702. In this way, when a workpiece is disposed between the first jaw 720 and the second jaw 732, the first clamp 702 and the second clamp 704 remain securely attached to the member 714 when an outward force is applied to the first jaw 720 and the second jaw 732 as further described below with respect to FIGS. 9a and 9b.

Progressing to the fourth stage 808, the second clamp 704 has been rotated (e.g., rotated clockwise) to achieve a second orientation. For instance, an angle 820 formed between the longitudinal axis 816 and the vertical axis 122, e.g., a vertical axis of the member 714, is a substantially perpendicular angle. As illustrated, in the second orientation the member 714 is disposed within the second partial mounting aperture 728.

The member 714 is misaligned with the opening of the second partial mounting aperture 728 such that the member 714 is constrained within the second partial mounting aperture 728. In accordance with the techniques described above, the second clamp 704 may further include one or more wings, apertures to house fasteners, and/or contact surfaces to further secure the second clamp 704 to the member 714 in the second orientation. The second clamp 704 may further be disposed in between the first orientation and the second orientation, such as to efficiently reposition the second clamp 704 along the vertical axis of the member 714.

FIGS. 9a and 9b depict an example usage scenario 900a, 900b of the lateral attachment clamp assembly 700 in accordance with one or more implementations described herein in a first stage 902 and a second stage 904. In this example, the first clamp 702 is affixed to an intermediate portion of a member 906. For instance, the first clamp 702 is disposed in the second orientation. In this example, the first clamp region 716 is not perpendicular to the member 906. Rather, a longitudinal axis 908 of the first clamp region 716 and a vertical axis 910 associated with the member 906 (depicted in the illustrated example as a side of the member 906) form an acute interior angle 912.

Further, as depicted in the first stage 902 the second clamp 704 is affixed to a different intermediate portion of the member 906 and is disposed in the second orientation. In this example, second clamp region 730 further forms an acute angle with the member 906. For instance, a longitudinal axis 914 of the second clamp region 730 forms an acute interior angle 916 with the vertical axis 910 of the member 906.

The acute interior angle 912 and the acute interior angle 916, for instance, are based on an anticipated deflection of the member 906, such as when an object, e.g., a workpiece, is clamped between the first jaw 720 and the second jaw 732. In various embodiments, a measure of either or both the acute interior angle 912 and/or the acute interior angle 916 are further based on a distance between the first clamp 702 and the second clamp 704. For instance, a relatively greater distance between the first clamp 702 and the second clamp 704 (e.g., a distance between respective positions along the vertical axis 910) corresponds to a greater deflection of the member 906. Thus, the first clamp 702 and/or the second clamp 704 are configured such that the acute interior angle 912 and/or the acute interior angle 916 are relatively smaller (e.g., more acute) than an example in which the distance between the first clamp 702 and the second clamp 704 is relatively small.

As shown in the second stage 904, a workpiece 918 is disposed between the first clamp 702 and the second clamp 704, e.g., secured between the first jaw 720 and the second jaw 732. Application of force by the first jaw 720 and the second jaw 732 to the workpiece 918 results in an opposing force, e.g., an upward force to the first clamp region 716 and a downward force to the second clamp region 730. This causes a deflection of the member 906, such as for the member 906 to “bow” outwards.

Accordingly, as illustrated an angle 920 between the longitudinal axis 908 of the first clamp region 716 and the vertical axis 910 of the member 906 is substantially perpendicular. Similarly, an angle 922 between the longitudinal axis 914 of the second clamp region 730 and the vertical axis 910 of the member 906 is substantially perpendicular. In this way, the configuration of the first clamp 702 and the second clamp 704 ensures that the first jaw 720 and the second jaw 732 are located in parallel planes when securing a workpiece 918, such as to maximize contact with the workpiece 918 and prevent slippage.

FIG. 10 depicts a lateral attachment clamp 1000 that includes a rotational component in accordance with one or more implementations described herein in a first stage 1002, a second stage 1004, and a third stage 1006. In this example, an engagement region 102 and a clamp region 104 of the lateral attachment clamp 1000 are attached via a rotational component 1008. A variety of rotational components are considered, such as one or more hinges, swivel joints, bearing mechanisms, lockable washers, gears, lockable elements, etc. The rotational component 1008, for instance enables rotation of the engagement region 102 relative to the clamp region 104. The rotational component 1008 is further operable to affix the lateral attachment clamp 1000 at one or more rotational orientations, such as to “lock” the clamp region 104 at a particular angle with respect to the engagement region 102.

For instance, as depicted in the first stage 1002, a longitudinal axis 1010 of the engagement region 102 and a longitudinal axis 1012 of the clamp region 104 form an angle 1014. Progressing to the second stage, the engagement region 102 has been rotated about the rotational component 1008 such that an angle 1016 formed by the longitudinal axis 1010 and the longitudinal axis 1012 is relatively smaller than the angle 1014. Progressing to the third stage, the engagement region 102 has been further rotated about the rotational component 1008 such that an angle 1018 formed by the longitudinal axis 1010 and the longitudinal axis 1012 is relatively smaller than both the angle 1014 and the angle 1016. In this way, the techniques described herein further support variable positioning of the engagement region 102 with respect to the engagement region 102 to provide for a variety of working scenarios.

Generally, the various structures and features discussed herein such as the lateral attachment clamps and assemblies are combinable in various ways including implementations not expressly illustrated herein to provide for a variety of different lateral attachment clamps and lateral attachment clamp assemblies.

### CONCLUSION

Accordingly, lateral attachment clamps and techniques associated with lateral attachment clamps are described. The lateral attachment clamps are usable to ensure precise and secure positioning of various workpieces while providing access for performing attachment and/or other work techniques thereon, which is not possible using conventional tools and techniques.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention. Additional aspects of the techniques, features, and/or methods discussed herein relate to one or more of the following:

In some aspects, the techniques described herein relate to a lateral attachment clamp including: a clamp region including a proximal end and a distal end, the proximal end of the clamp region including a clamp component, a longitudinal axis of the clamp region extending between the proximal end and the distal end; and an engagement region including a proximal end and a distal end, the proximal end of the engagement region attached at an angle to the distal end of the clamp region, the engagement region including a partial mounting aperture disposed between the proximal end and the distal end of the engagement region, the partial mounting aperture including an opening dimensioned to align with a vertical axis in a first orientation of the lateral attachment clamp and intersect with the vertical axis in a second orientation of the lateral attachment clamp, the vertical axis substantially perpendicular to the longitudinal axis of the clamp region when the lateral attachment clamp is in the second orientation.

In some aspects, the techniques described herein relate to a lateral attachment clamp, wherein the partial mounting aperture further includes one or more wings located on one or more sides of the opening, the one or more wings parallel to the vertical axis in the first orientation and at least one of the wings is configured to intersect the vertical axis in the second orientation.

In some aspects, the techniques described herein relate to a lateral attachment clamp, wherein the one or more wings are tapered such that a width of the one or more wings is variable along a length of the one or more wings.

In some aspects, the techniques described herein relate to a lateral attachment clamp, the partial mounting aperture further including one or more contact faces on an interior surface of the partial mounting aperture, the one or more contact faces substantially parallel to the vertical axis in the second orientation.

In some aspects, the techniques described herein relate to a lateral attachment clamp, wherein a side surface of the engagement region includes one or more apertures that extend into the interior surface of the engagement region, the one or more apertures configured to house one or more fasteners.

In some aspects, the techniques described herein relate to a lateral attachment clamp, wherein the clamp component includes a jaw located in a transverse plane, the transverse plane substantially perpendicular to the vertical axis when the lateral attachment clamp is positioned in the second orientation.

In some aspects, the techniques described herein relate to a lateral attachment clamp, wherein a longitudinal axis of the engagement region and the longitudinal axis of the clamp region form an obtuse angle, the obtuse angle in a range of 145 to 165 degrees.

In some aspects, the techniques described herein relate to a lateral attachment clamp, wherein the vertical axis is a vertical axis of a member, the opening dimensioned such that in the first orientation the member is insertable into the opening and upon rotation of the lateral attachment clamp from the first orientation to the second orientation the member is misaligned with the opening to constrain the member within the partial mounting aperture.

In some aspects, the techniques described herein relate to a lateral attachment clamp that is attachable to an intermediate portion of a member, the lateral attachment clamp including: an engagement region including a proximal end and a distal end, the engagement region including a partial mounting aperture disposed between the proximal end and the distal end and dimensioned to attach the lateral attachment clamp to the member while in a first orientation and secure the lateral attachment clamp to the member in a second orientation; and a clamp region including a proximal end and a distal end, the distal end of the clamp region attached at an angle to the proximal end of the engagement region, the proximal end of the clamp region including a clamp component including a jaw positionable in a transverse plane, the transverse plane substantially perpendicular to the member in the second orientation.

In some aspects, the techniques described herein relate to a lateral attachment clamp, wherein the partial mounting aperture includes an opening such that in the first orientation the member is insertable into the lateral attachment clamp through the opening and wherein upon rotation of the lateral attachment clamp from the first orientation to the second orientation the member is misaligned with the opening to constrain the member within the lateral attachment clamp.

In some aspects, the techniques described herein relate to a lateral attachment clamp, wherein the partial mounting aperture further includes one or more wings located on one or more sides of the opening, the one or more wings configured to at least partially enclose the member within the partial mounting aperture in the second orientation of the lateral attachment clamp.

In some aspects, the techniques described herein relate to a lateral attachment clamp, wherein the one or more wings are tapered to accommodate variable member widths.

In some aspects, the techniques described herein relate to a lateral attachment clamp, wherein an internal surface of the partial mounting aperture includes one or more contact faces to secure the member within the partial mounting aperture in the second orientation.

In some aspects, the techniques described herein relate to a lateral attachment clamp, wherein the proximal end of the clamp region includes an aperture and the clamp component includes a spindle with a proximal end and a distal end movably positioned within the aperture, the proximal end of the spindle attached to the jaw and the distal end of the spindle attached to an actuation component to control a position of the jaw relative to the aperture.

In some aspects, the techniques described herein relate to a lateral attachment clamp, wherein the aperture is dimensioned to house a tapped insert and the spindle includes a threaded rod dimensioned to engage with the tapped insert.

In some aspects, the techniques described herein relate to a lateral attachment clamp, wherein the tapped insert includes a notch dimensioned to coincide with a corresponding notch of the aperture to secure the tapped insert within the aperture at a rotational position.

In some aspects, the techniques described herein relate to a lateral attachment clamp assembly including: a first lateral attachment clamp having a proximal end and a distal end, the distal end including a first engagement region including a first partial mounting aperture, the first partial mounting aperture dimensioned to attach the first lateral attachment clamp to an intermediate portion of a member while in a first orientation and affix the first lateral attachment clamp to the intermediate portion in a second orientation, the proximal end including a first clamp region including a clamp component with a first jaw, the first jaw located in a first transverse plane when the first lateral attachment clamp is in the second orientation; and a second lateral attachment clamp having a proximal end and a distal end, the distal end including a second engagement region including a second partial mounting aperture, the second partial mounting aperture dimensioned to attach the second lateral attachment clamp to a different intermediate portion of the member while in a first orientation and affix the second lateral attachment clamp to the different intermediate portion in a second orientation, the proximal end including a second clamp region including a second jaw located in a second transverse plane when the second lateral attachment clamp is in the second orientation, the second transverse plane substantially parallel to the first transverse plane.

In some aspects, the techniques described herein relate to a lateral attachment clamp assembly, wherein the first partial mounting aperture includes an opening such that in the first orientation the member is insertable into the first lateral attachment clamp through the opening and upon rotation of the first lateral attachment clamp from the first orientation to the second orientation the member is misaligned with the opening to constrain the member within the first lateral attachment clamp.

In some aspects, the techniques described herein relate to a lateral attachment clamp assembly, wherein the second partial mounting aperture includes an opening such that in the first orientation the member is insertable into the second lateral attachment clamp through the opening and upon rotation of the second lateral attachment clamp from the first orientation to the second orientation the member is misaligned with the opening to constrain the member within the second lateral attachment clamp.

In some aspects, the techniques described herein relate to a lateral attachment clamp assembly, wherein the first lateral attachment clamp is positioned in the second orientation and the second lateral attachment clamp is positioned in the second orientation, and one or more of a longitudinal axis of the first clamp region or a longitudinal axis of the second clamp region form an acute angle with the member, a measure of the acute angle based on an anticipated deflection of the member.

What is claimed is:

1. A lateral attachment clamp comprising:
a clamp region including a proximal end and a distal end, the proximal end of the clamp region including a clamp component, a longitudinal axis of the clamp region extending between the proximal end and the distal end; and
an engagement region including a proximal end and a distal end, the proximal end of the engagement region attached at an angle to the distal end of the clamp region, the engagement region including a partial mounting aperture disposed between the proximal end and the distal end of the engagement region, the partial mounting aperture including an opening dimensioned to align with a vertical axis in a first orientation of the lateral attachment clamp and intersect with the vertical axis in a second orientation of the lateral attachment clamp, the vertical axis substantially perpendicular to the longitudinal axis of the clamp region when the lateral attachment clamp is in the second orientation.

2. The lateral attachment clamp as described in claim 1, wherein the partial mounting aperture further includes one or more wings located on one or more sides of the opening, the one or more wings parallel to the vertical axis in the first orientation and at least one of the wings is configured to intersect the vertical axis in the second orientation.

3. The lateral attachment clamp as described in claim 2, wherein the one or more wings are tapered such that a width of the one or more wings is variable along a length of the one or more wings.

4. The lateral attachment clamp as described in claim 1, the partial mounting aperture further including one or more contact faces on an interior surface of the partial mounting aperture, the one or more contact faces substantially parallel to the vertical axis in the second orientation.

5. The lateral attachment clamp as described in claim 4, wherein a side surface of the engagement region includes one or more apertures that extend into the interior surface of the engagement region, the one or more apertures configured to house one or more fasteners.

6. The lateral attachment clamp as described in claim 1, wherein the clamp component includes a jaw located in a transverse plane, the transverse plane substantially perpendicular to the vertical axis when the lateral attachment clamp is positioned in the second orientation.

7. The lateral attachment clamp as described in claim 1, wherein a longitudinal axis of the engagement region and the longitudinal axis of the clamp region form an obtuse angle, the obtuse angle in a range of 145 to 165 degrees.

8. The lateral attachment clamp as described in claim 1, wherein the vertical axis is a vertical axis of a member, the opening dimensioned such that in the first orientation the member is insertable into the opening and upon rotation of the lateral attachment clamp from the first orientation to the second orientation the member is misaligned with the opening to constrain the member within the partial mounting aperture.

9. A lateral attachment clamp that is attachable to an intermediate portion of a member, the lateral attachment clamp comprising:
an engagement region including a proximal end and a distal end, the engagement region including a partial mounting aperture disposed between the proximal end and the distal end and dimensioned to attach the lateral attachment clamp to the member while in a first orientation and secure the lateral attachment clamp to the member in a second orientation; and
a clamp region including a proximal end and a distal end, the distal end of the clamp region attached at an angle to the proximal end of the engagement region, the proximal end of the clamp region including a clamp component including a jaw positionable in a transverse plane, the transverse plane substantially perpendicular to the member in the second orientation.

10. The lateral attachment clamp as described in claim 9, wherein the partial mounting aperture includes an opening such that in the first orientation the member is insertable into the lateral attachment clamp through the opening and wherein upon rotation of the lateral attachment clamp from the first orientation to the second orientation the member is misaligned with the opening to constrain the member within the lateral attachment clamp.

11. The lateral attachment clamp as described in claim 10, wherein the partial mounting aperture further includes one or more wings located on one or more sides of the opening, the one or more wings configured to at least partially enclose the member within the partial mounting aperture in the second orientation of the lateral attachment clamp.

12. The lateral attachment clamp as described in claim 11, wherein the one or more wings are tapered to accommodate variable member widths.

13. The lateral attachment clamp as described in claim 9, wherein an internal surface of the partial mounting aperture includes one or more contact faces to secure the member within the partial mounting aperture in the second orientation.

14. The lateral attachment clamp as described in claim 9, wherein the proximal end of the clamp region includes an aperture and the clamp component includes a spindle with a proximal end and a distal end movably positioned within the aperture, the proximal end of the spindle attached to the jaw and the distal end of the spindle attached to an actuation component to control a position of the jaw relative to the aperture.

15. The lateral attachment clamp as described in claim 14, wherein the aperture is dimensioned to house a tapped insert and the spindle includes a threaded rod dimensioned to engage with the tapped insert.

16. The lateral attachment clamp as described in claim 15, wherein the tapped insert includes a notch dimensioned to coincide with a corresponding notch of the aperture to secure the tapped insert within the aperture at a rotational position.

17. A lateral attachment clamp assembly comprising:
a first lateral attachment clamp having a proximal end and a distal end, the distal end including a first engagement region including a first partial mounting aperture, the first partial mounting aperture dimensioned to attach the first lateral attachment clamp to an intermediate portion of a member while in a first orientation and affix the first lateral attachment clamp to the intermediate portion in a second orientation, the proximal end including a first clamp region including a clamp component with a first jaw, the first jaw located in a first transverse plane when the first lateral attachment clamp is in the second orientation; and
a second lateral attachment clamp having a proximal end and a distal end, the distal end including a second engagement region including a second partial mounting aperture, the second partial mounting aperture dimensioned to attach the second lateral attachment clamp to a different intermediate portion of the member while in a first orientation and affix the second lateral attachment clamp to the different intermediate portion in a second orientation, the proximal end including a second clamp region including a second jaw located in a second transverse plane when the second lateral attachment clamp is in the second orientation, the second transverse plane substantially parallel to the first transverse plane.

18. The lateral attachment clamp assembly as described in claim 17, wherein the first partial mounting aperture includes an opening such that in the first orientation the member is insertable into the first lateral attachment clamp through the opening and upon rotation of the first lateral attachment clamp from the first orientation to the second orientation the member is misaligned with the opening to constrain the member within the first lateral attachment clamp.

19. The lateral attachment clamp assembly as described in claim 18, wherein the second partial mounting aperture includes an opening such that in the first orientation the member is insertable into the second lateral attachment clamp through the opening and upon rotation of the second lateral attachment clamp from the first orientation to the second orientation the member is misaligned with the opening to constrain the member within the second lateral attachment clamp.

20. The lateral attachment clamp assembly as described in claim 17, wherein the first lateral attachment clamp is positioned in the second orientation and the second lateral attachment clamp is positioned in the second orientation, and one or more of a longitudinal axis of the first clamp region or a longitudinal axis of the second clamp region form an acute angle with the member, a measure of the acute angle based on an anticipated deflection of the member.
